(19) United States
(12) Patent Application Publication
(10) Pub. No.: US 2007/0057915 A1
(43) Pub. Date: Mar. 15, 2007

(54) Input system

(75) Inventor: Shouji Yamauchi, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/521,383

(22) Filed: Sep. 15, 2006

(30) Foreign Application Priority Data
Sep. 15, 2005 (JP) 2005-268514
Jul. 28, 2006 (JP) 2006-207002

(51) Int. Cl. G09G 5/00

(52) U.S. Cl. 345/156

(57) ABSTRACT

An input system for a vehicular device includes a display unit for displaying plural menu items, an operation unit for inputting instructions, a position detector for detecting the operation of the operation unit, a pointer control unit for pointing the plural menu items, an input determination unit for determining a selection input of the menu item, and an input process unit for processing the selection input.

### CROSS REFERENCE TO RELATED APPLICATION

This application is based on and claims the benefit of priority of Japanese Patent Application No. 2005-268514 filed on Sep. 15, 2005, and No. 2006-207002 filed on Jul. 28, 2006, the disclosure of which is incorporated herein by reference.

### FIELD OF THE INVENTION

The present invention generally relates to an input device for use in a vehicle.

### BACKGROUND OF THE INVENTION

Conventionally, an input system having a display unit are used to input data and/or an instruction to vehicular apparatus such as a navigation system air-conditioner, an audio system or the like. The display unit is used to provides operation data and/or vehicle conditions for a user, i.e., a driver of a vehicle. The display unit is positioned on an upper part of an instrument panel for an improved visibility of the user. The input system disclosed in Japanese patent document JP-A-H11-110132 describes utilization of a touch panel on the display unit that facilitates an input of the user.

However, the position of the touch panel on the instrument panel makes it difficult for the user to casually provide an input for the input system, or, in other words, makes it difficult to reach out to the touch panel. Therefore, the input device having an input unit that is positioned in an easily operable position (e.g., around a center console close to a driver's seat) without compromising the visibility of the display unit has been desired.

In addition, input operations by using the input unit and the display unit increase the degree of complication when the input system organizes an interface of required input in a hierarchical manner to provide increased number of functions through a limited display space on the display unit. In other words, the operation of the input system may now be a too troublesome and time consuming procedure to be involved while the user is driving a vehicle. Therefore, a simplified and quick operation of the input system has been strongly desired.

Further, the input system utilizing the touch panel is also problematic because the input from the touch panel does not provide a feedback such as a click sound, a mechanical movement or the like for the user when the input system is operated. Therefore, the input system having a mechanical feedback for the user through an operation unit such as an operation switch or a lever has been desired. That is, the input system having a feedback for the user to provide an improved controllability has been desired when it is used in the vehicle by the driver being involved in, for example, a driving operation.

### SUMMARY OF THE INVENTION

In view of the above-described and other problems, the present disclosure describes an input system that provides for a user an improved controllability through a mechanical feedback from an input unit in an easily operable position in association with a display unit in an easily viewable position from the user.

In one aspect of the present disclosure, the input system for a vehicular device includes a display unit for displaying plural menu items, an operation unit for inputting instructions at a position closer to the user, a position detector for detecting the operation of the operation unit, a pointer control unit for pointing the plural menu items, an input determination unit for determining a selection input of the menu item, and an input process unit for processing the selection input. Therefore, the input system is easily operable and easily viewable. Further, the operation of the operation unit restricted in a linear direction provides an intuitive operation for the user because of the arrangement of the menu items that simulates the linear operation. In addition, the menu items may be represented by LEDs on the display unit or buttons in the screen for improved operability.

In another aspect of the present disclosure, the input system has the menu items arranged in two dimensional space on the display in association with the operation unit that is operable in an intuitive manner in terms of operation directions and an actual operation feel of the operation unit. That is, the operation of the operation unit is guided by a guide rail or the like for intuitive transition of selection between the menu items, and the feedback from the operation of the operation unit provides an assurance of the operation of the input system for the user in combination with a representation on the display unit. In addition, because of the improvement of assurance of the operation intended for controlling a certain function of the vehicular device, the feedback from the input system provides improved safety for the user when the user operates the input system while being involved in a driving operation or the like. Further, the arrangement of the menu items on the screen is changed based on a vehicle speed. In this manner, the control for operating the operation unit is simplified for not compromising other operations by the user. Furthermore, the operation of the operation unit in the two-dimensional space may be replaced with the linear operation in one direction in association with a rotational input for the other direction. In this manner, the operation of the operation unit becomes more intuitive because of the decreased number of the controls.

### BRIEF DESCRIPTION OF THE DRAWINGS

Other objects, features and advantages of the present invention will become more apparent from the following detailed description made with reference to the accompanying drawings, in which:

FIGS. 1A and 1B show plan views of an input system in an embodiment of the present disclosure;

FIGS. 1C and 1D show cross-sectional views of the input system in an embodiment of the present disclosure;

FIG. 2 shows a block diagram of the input system;

FIG. 3 shows a flowchart of a process for controlling the input system;

FIG. 4 shows a side view of an operation unit of the input system;

FIG. 5A shows a top view of the operation unit of the input system;

FIGS. 5B to 5D show illustrations of a gravity center of the operation unit;

FIG. 5E shows a cross-sectional view of the operation unit;

FIG. 6 shows a block diagram of the input system having the operation unit illustrated in FIG. 4;

FIG. 7 shows a flowchart of a process for controlling the input system having the operation unit illustrated in FIG. 4;

FIGS. 8A and 8B show the plan views of the input system in a different embodiment;

FIG. 8C shows a cross-sectional view of the operation unit in the different embodiment;

FIG. 9 shows a block diagram of the input system having the operation unit illustrated in FIG. 8B;

FIG. 10 shows a flowchart of a process for controlling the input system having the operation unit illustrated in FIG. 8B;

FIGS. 11A and 11B show the plan views of the input system in a yet different embodiment;

FIG. 12 shows an illustration of the input system installed in a vehicle;

FIG. 13 shows another illustration of the input system installed in the vehicle;

FIG. 14 shows an illustration of a guide slot with a cross-section of a post of the operation unit;

FIG. 15 shows another illustration of the guide slot with the cross-section of the post of the operation unit;

FIGS. 16A and 16B show illustrations of position detection areas and icons of the input system;

FIGS. 16C and 16D show cross-sectional views of the input system;

FIG. 17 shows a detailed block diagram of a control circuit of the input system;

FIGS. 18A and 18B show examples of a display unit of the input system;

FIGS. 19A and 19B show different examples of the display unit of the input system;

FIG. 20 shows a flowchart of the process for controlling the input system shown in FIGS. 19A and 19B;

FIGS. 21A and 21B show illustrations of a touch panel of a position detector; and

FIG. 22 shows an illustration of the guide slot with the cross-section of the post of the operation unit in a different operation condition relative to the guide slot shown in FIG. 14.

### DETAILED DESCRIPTION OF THE PREFERRED EMBODIMENTS

Embodiments of the present disclosure are described with reference to the drawings. The embodiments of the present disclosure are not necessarily limited to the types/forms in the present embodiments, but may take any form of the art or technique that is regarded within a scope of the present disclosure by artisans who have ordinary skill in the art.

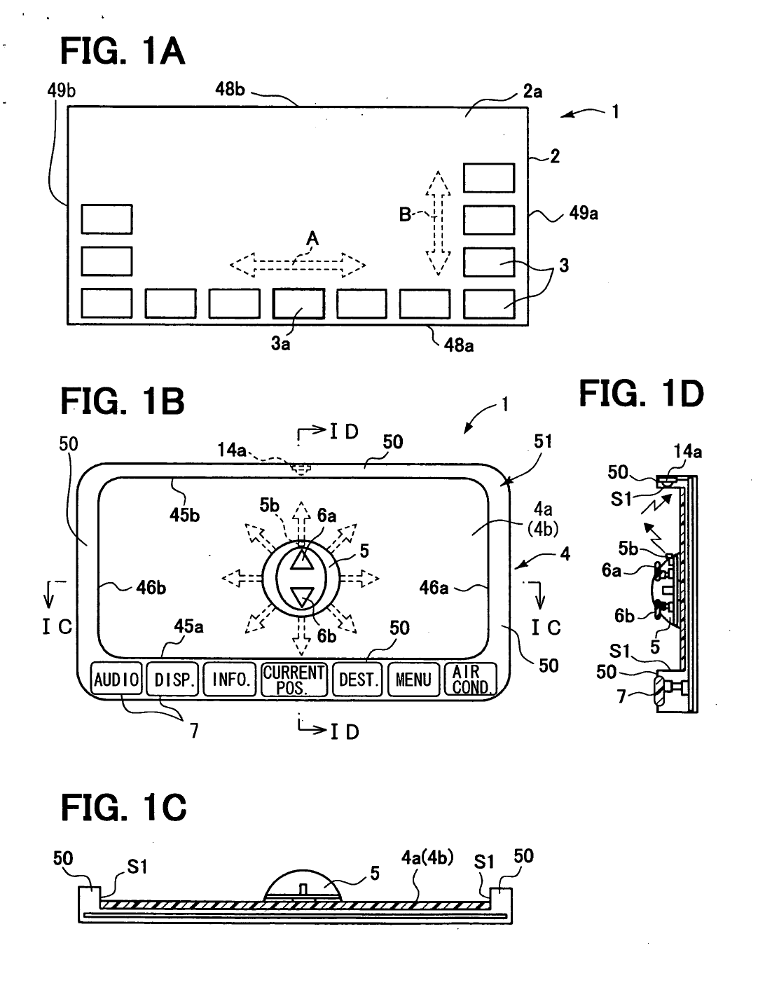

FIGS. 1A, 1B, 1C, 1D show a plan view and cross-sectional views of an input system 1 in an embodiment of the present disclosure. In the plan view, the input system 1 is illustrated as a display unit 2 in FIG. 1A and a position detector 4 in FIG. 1B. The position detector 4 is also shown as a cross section in FIGS. 1C, 1D. The display unit 2 is using a liquid crystal for displaying a screen 2a. The screen 2a includes plural selection positions 3 arranged in a predetermined direction. The selection position 3 is highlighted as a selected button 3a when it is in a selected condition. The display unit 2 is disposed on an instrument panel of a vehicle in a position being viewable by occupants or users seated in front seats.

An operation unit 5 is disposed on a right or left side of a seat occupied by the user for access and operation by the user. The operation unit 5 is operable in a manner that corresponds to the direction of the arrangement of the selection positions 3. That is, the operation unit 5 is at least linearly operable in a predetermined direction. More practically, the operation unit 5 is operable in an operation plane 4a that physically represents the screen 2a of the display unit 2, and the operation of the operation unit 5 is bound in a first and a second direction. The first direction corresponds to a first array A of the selection positions 3 in the screen 2a, and the second direction corresponds to a second array B of the selection positions 3 in the screen 2a. The selected button 3a is moved according to an operation of the operation unit 5. The operation unit 5 includes an OK switch 6a and a cancel switch 6b for determining and canceling an input from the operation unit 5.

The operation unit 5 is preferably disposed on a center console C of the vehicle for the operability. The operation unit 5 provides a controllability, or a controllable feeling, for the user because, by controlling the operation unit 5 with a hand, the user can experience a simulated operation of a controlled object that is under the control of the user.

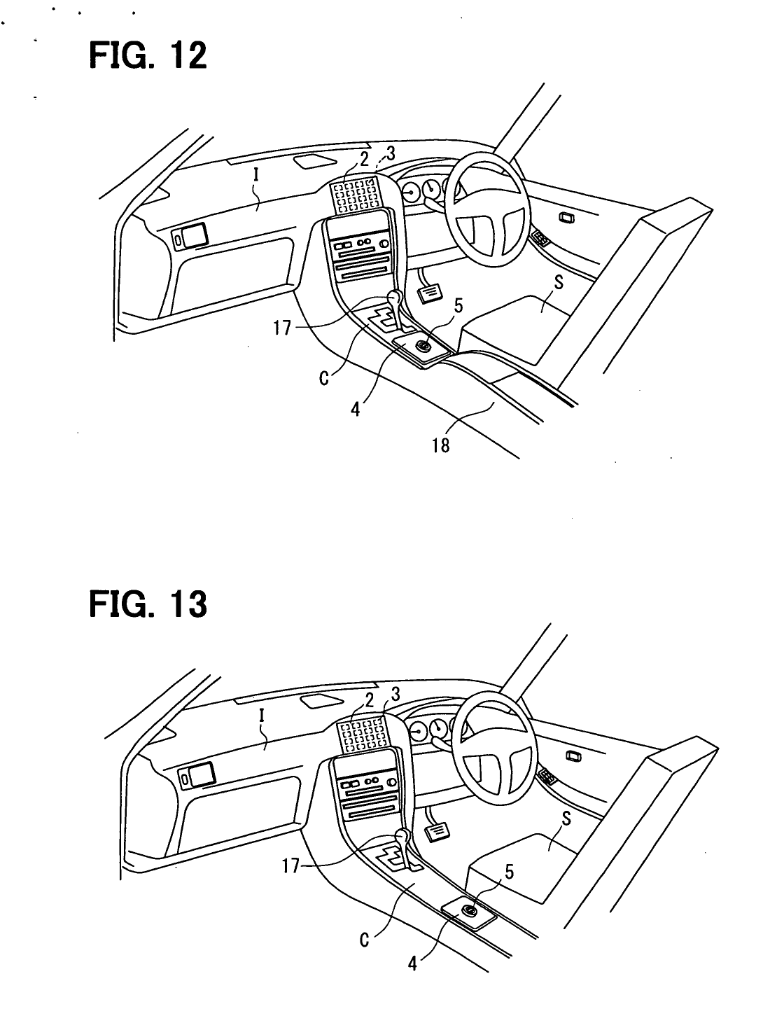

FIG. 12 shows a detailed illustration of the input system 1 implemented in the vehicle. The operation unit 5 and the position detector 4 are disposed diagonally in front of the user between a console box 18 and an instrument panel I (or a shift lever 17 in a center console C. The position of the operation unit 5 and the position detector 4 is easily accessible by the user in a seat S, thereby providing operability for the user. The display unit 2 is disposed in an upper part of the instrument panel I, and is easily viewable by the user. The operation unit 5 and the position detector 4 may be disposed on right beside the user for the accessibility and the operability as shown in FIG. 13. That is, the position of the operation unit 5 on the right or left of the user (i.e., the seat S) in the present disclosure ranges from an immediate lateral position of the user to a diagonal front position of the user as described above with reference to the illustrations in FIGS. 12 and 13.

The position detector 4 is implemented as a touch panel in the present embodiment. That is, a touching position of the operation unit 5 is detected by the touch panel of the position detector 4. In addition, a determination input signal is wirelessly transmitted to the input system 1 from the operation unit 5 when the switch 6a or 6b in the operation unit 5 is operated. A lower portion of the position detector 4 has plural menus 7 for directly controlling the display unit 2.

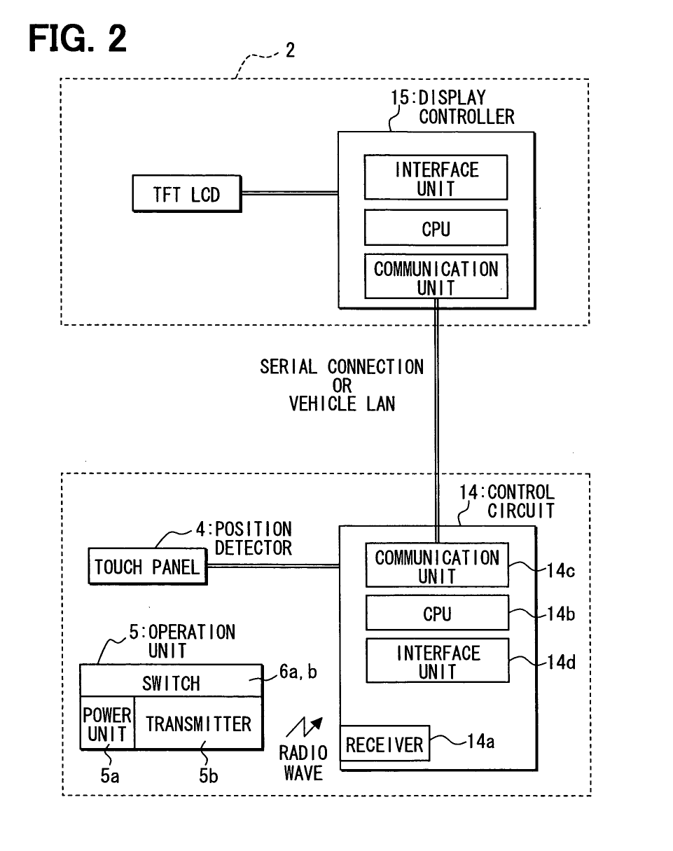

FIG. 2 shows a block diagram of the input system 1. The display unit 2 of the input system 1 is disposed on an instrument panel of the vehicle. The display unit 2 has a display screen made from thin film transistors (TFT) and a display controller 15 for controlling a content of the display screen. The position detector 4 (e.g., the touch panel) and the operation unit 5 are disposed either on a right side or a left side of the user. The operation unit 5 includes switches 6a, 6b, and a transmitter 5b for wirelessly transmitting the determination input signal, a power unit 5a for providing an electric power for the transmitter 5b. The position detector 4 is coupled with a control circuit 14. The operation position or the positional information of the operation unit 5 is sent to the control circuit 14. The control circuit 14 includes a receiver 14a that is used for receiving the signal transmitted from the switches 6a, 6b when the switches 6a, 6b are operated. The control circuit 14 also includes a communication unit 14c, a calculation unit (CPU) 14b, an interface unit 14d for converting X-Y coordinates of the operation unit 5 on the position detector 4 to X-Y coordinates of the display unit 2. Further, the control circuit 14 transmits an operation signal to the display unit 2 for indicating the operation of the switches 6a, 6b. The signal from the control circuit 14 to the display controller 15 is transmitted through a serial connection, a vehicle LAN or the like. The signal from the control circuit 14 is received by the controller 15 for displaying a pointer on the screen 2a of the display unit 2. That is, the control circuit 14 and the display controller 15 cooperatively control the pointer on the screen 2a by exchanging the signal therebetween.

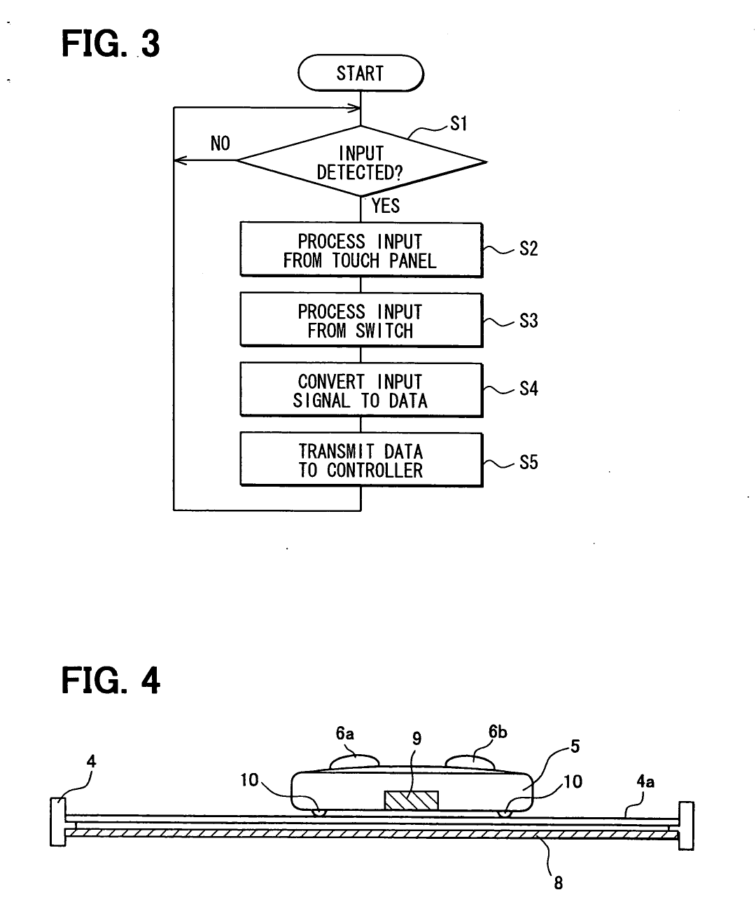

FIG. 3 shows a flowchart of a process for controlling the operation of the operation unit 5 and the position detector 4.

In step S1, the process in the control circuit 14 checks an input from the position detector 4 in a predetermined interval for detecting the operation position of the operation unit 5. The process proceeds to step S2 when the input is detected (step S1:YES). The process repeats the input detection when input from the position detector 4 is not detected (step S1:NO).

In step S2, the process detects the input operation from the operation unit 5, that is, the operation position of the operation unit 5 by the user is detected by the position detector 4.

In step S3, the process detects the input operation of the switches 6a, 6b.

In step S4, the process converts the operation position of the operation unit 5 to the coordinates of the display unit 2. The operation signal from the switches 6a, 6b upon detecting a press on the switches 6a, 6b is converted to a command for controlling a function of a vehicular device.

In step S5, the process sends coordinate information and the command to the display controller 15 as control data.

As the illustrations in FIGS. 1A, 1B show, the display unit 2 is a two-dimensional display apparatus that has the first array A of the menu items 3 and the second array B of the selection positions 3 on the screen 2a in crisscross positions, and the operation of the operation unit 5 is slidably bound along the operation plane 4a that simulates the two-dimensional space in the screen 2a. More practically, the operation unit 5 is operable along the operation plane 4a for two dimensional input for controlling transition of the selected condition among the selection positions 3 arranged in the first and the second arrays A, B. The control circuit 14 determines a display position of the highlighted selection position 3 on the screen 2a based on the operation position of the operation unit 5 detected by the position detector 4.

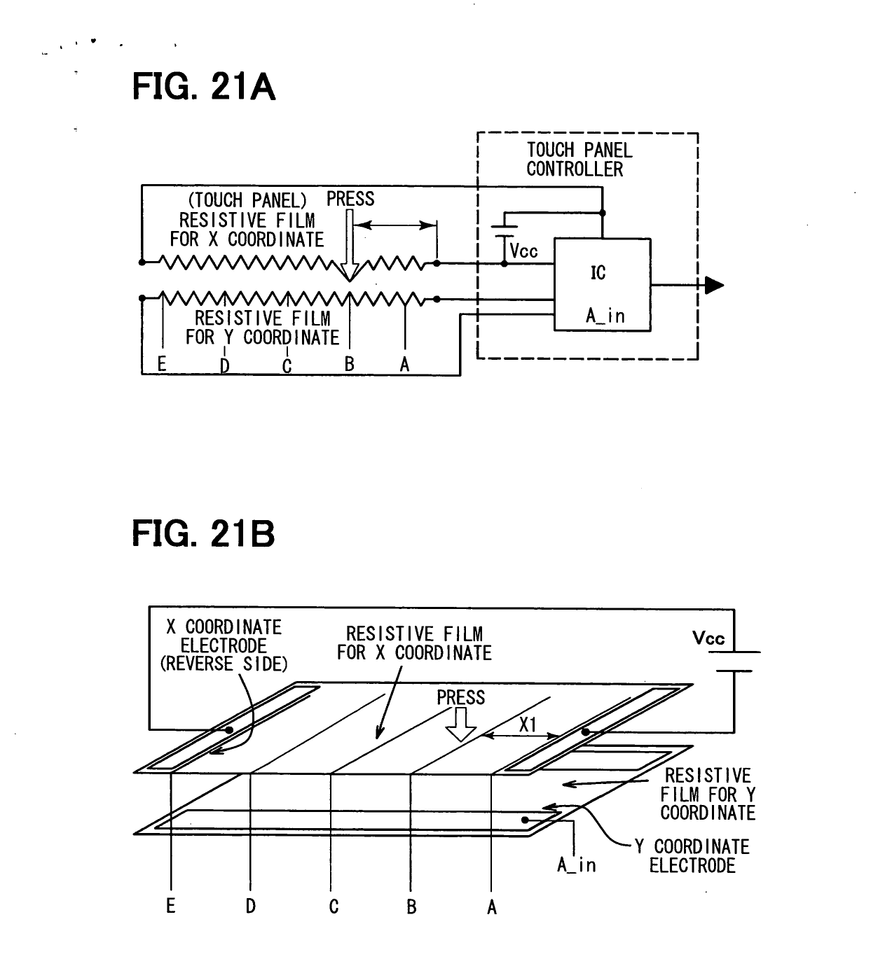

The position detector 4 is an array of detection mechanisms on the operation plane 4a for detecting a pointer on the operation unit 5. The position detector 4 detects the operation position of the operation unit 5 by outputting an electrical signal as a position signal from the detection mechanism at the operation position of the operation unit 5. That is, the position detector 4 is composed of a planar position detecting device. For example, the position detector 4 is a touch panel having a resistive film for sensing the operation position of the operation unit 5 as shown in FIGS. 21A, 21B. The resistive film is made by binding conducting layers with film-like material for sensing a touch of the operation unit 5 on its surface. The conducting layers respectively represent X coordinate and Y coordinate for positioning the operation unit 5. The touch of the operation unit 5 converts the operation position of the operation unit 5 (point X1) to the electrical signal by conducting the two conducting layers at the operation position. The electrical signal based on an applied voltage Vcc is detected by the position detector 4 to be AND converted for determining the X/Y coordinates of the operation position.

In the illustration in FIG. 1B, the input system 1 of the present disclosure has an operation plane frame 4b for defining the operation plane 4a, and an operation guide rail 50 at an outer periphery of the operation plane 4a on the operation plane frame 4b for guiding the operation of the operation unit 5 along an outer periphery of the operation plane 4a and prohibiting the operation of the operation unit 5 toward an outside of the operation plane 4a. The plural selection positions 3 on the screen 2a are arranged in a linear direction that corresponds to an operation direction of the operation unit 5 along the operation plane frame 4b. In this manner, the operation unit 5 can be intuitively operable along the operation guide rail 50 without watching the operation unit when, for example, the user is driving the vehicle.

The operation of the operation unit 5 along the operation guide rail 50 enables the user to intuitively select one of the selection positions 3 arranged in a row along the periphery of the screen 2a because the operation of the operation unit 5 along the operation guide rail 50 simulates the transition between the arrangement of the selection positions 3 on the screen 2a.

The operation plane 4a has an oblong rectangular shape as show in FIG. 1B, and the operation guide rail 50 is disposed along a longer side 45a of the oblong rectangle on a near side relative to the user. The screen 2a in the shape of the oblong rectangle simulates the operation plane 4a, and the plural selection positions 3 are arranged along a lower side 48a of the screen 2a. In this manner, the operation guide rail 50 is formed along the longer side 45a of the operation plane 4a, thereby providing for the user an easy access and operability in terms of the operation along the operation guide rail 50.

Furthermore, the at least one of a right side 46a and a left side 46b of the operation plane 4a has the operation guide rail 50 disposed thereon, and the plural selection positions 3 are arranged on at least one of the right and left sides 46a, 46b of the screen 2a in a corresponding manner. In this case, the operation guide rail 50 extends to at least one of the right/left sides 46a, 46b of the operation plane frame 4b in addition to the longer side 45a, thereby improves the usability of the operation plane 4a.

The operation guide rail 50 protrudes from the operation plane 4a for guiding the operation of the operation unit 5 in an abutting manner. Therefore, the user can easily operate the operation unit 5 along the operation guide rail 50. In addition, the abutment of the operation unit 5 to the operation guide rail 50 enables the user to have a mechanical operation feedback from the operation guide rail 50.

Further, the position detector 4 surrounds the operation plane 4a, and the position detector 4 has a peripheral protruding unit 51 equipped with an operation restriction surface S1 in contact with the operation unit 5 as an inside exposed surface for prohibiting the operation of the operation unit 5 toward an outside of the operation plane 4. The peripheral protruding unit 51 has a switch for the plural menus 7 described above, and at least a portion of the peripheral protruding unit 51 is used as the operation guide rail 50. In this manner, the peripheral protruding unit 51 prohibits the operation of the operation unit 5 toward an outside of the operation plane 4a, thereby enabling the operation unit 5 to be movable within the operation plane 4a even when the disturbance to the operation is caused by, for example, the vibration of a running vehicle.

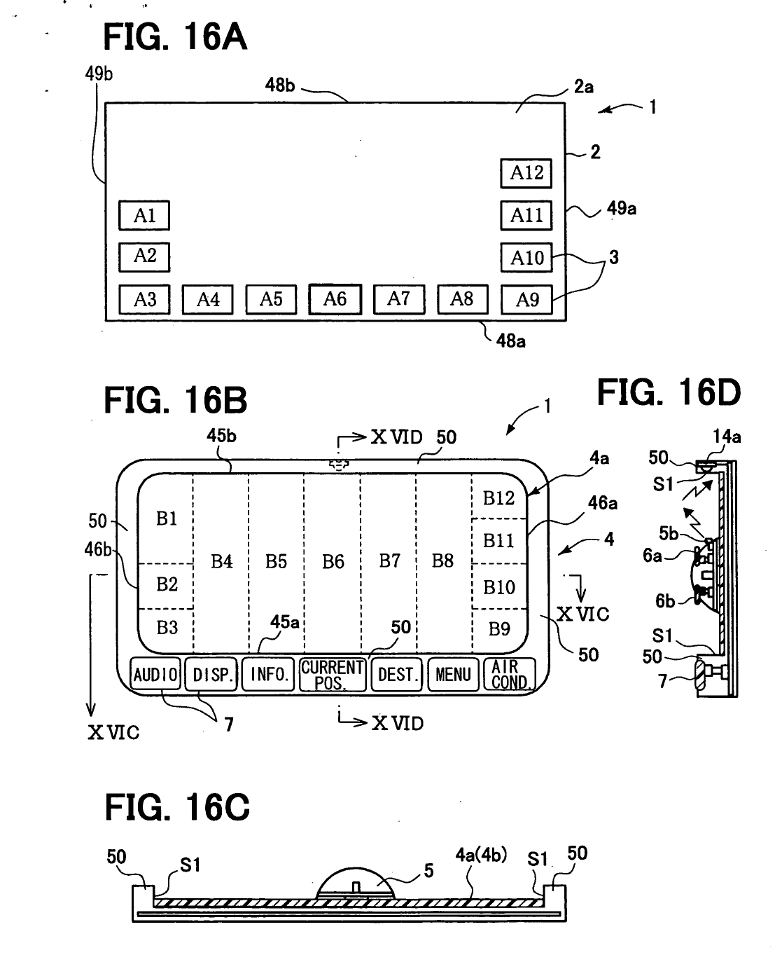

FIGS. 16A, 16B, 16C, 16D show illustrations of the display unit 2 and the operation plane 4a with cross-sectional views. The screen 2a has plural peripheral icons A1 to A12 arranged along its periphery, respectively corresponding to the selection positions 3 described before. Further, plural position detection areas B1 to B12 respectively corresponding to the peripheral icons A1 to A12 are formed on the operation plane 4a. In this manner, selection of one of the peripheral icons A1 to A12 by operating the operation unit 5 is determined when the operation position is detected in one of the position detection areas B1 to B12. That is, the user can select one of the peripheral icons A1 to A12 by operating the operation unit 5. Each of the peripheral icons A1 to A12 has an assignment of specific vehicular function. Therefore, the user can execute the specific vehicular function by selecting one of the peripheral icons A1 to A12.

When one of the plural peripheral icons A1 to A12 is in a selected condition, it is highlighted on the screen relative to the icons in a non-selected condition as a replacement of the selection mark. In FIG. 16A, the icon A6 is an example of a highlighted icon in the selected condition. In this manner, the user can quickly recognize the peripheral icon in the selected condition.

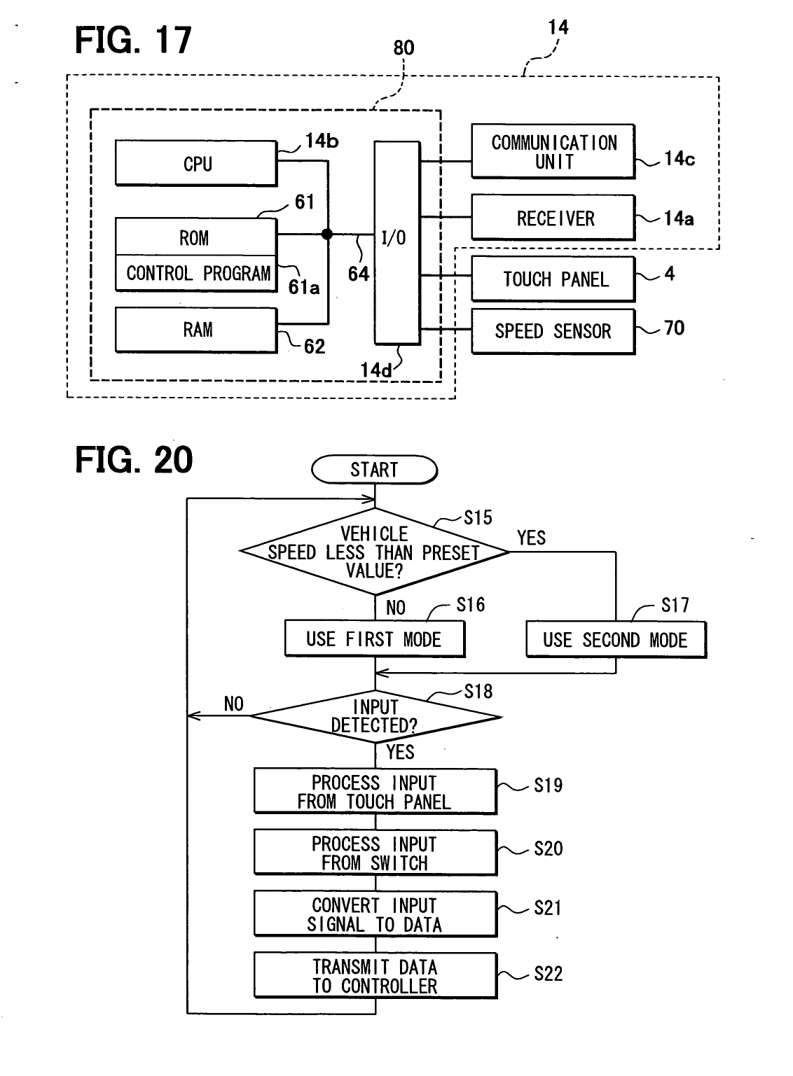

FIG. 17 shows a detailed block diagram of the control circuit 14 appeared in FIG. 2. The control circuit 14 includes a microcomputer 80 that takes charge of control. The microcomputer 80 includes a CPU 14b as a calculation unit, a ROM 61 storing a control program 61a, a RAM 62, an I/O 14d, and a bus line 64 that connects above described parts in the microcomputer 80. The CPU 14b retrieves the control program 61a from the ROM 61 and executes the program 61a on the RAM 62 for determining vehicle speed, for controlling selection of icons, and for switching icon selection modes. The I/O 14d is coupled to the receiver 14a, the communication unit 14c, the touch panel 4, and a speed sensor 70 for detecting vehicle speed.

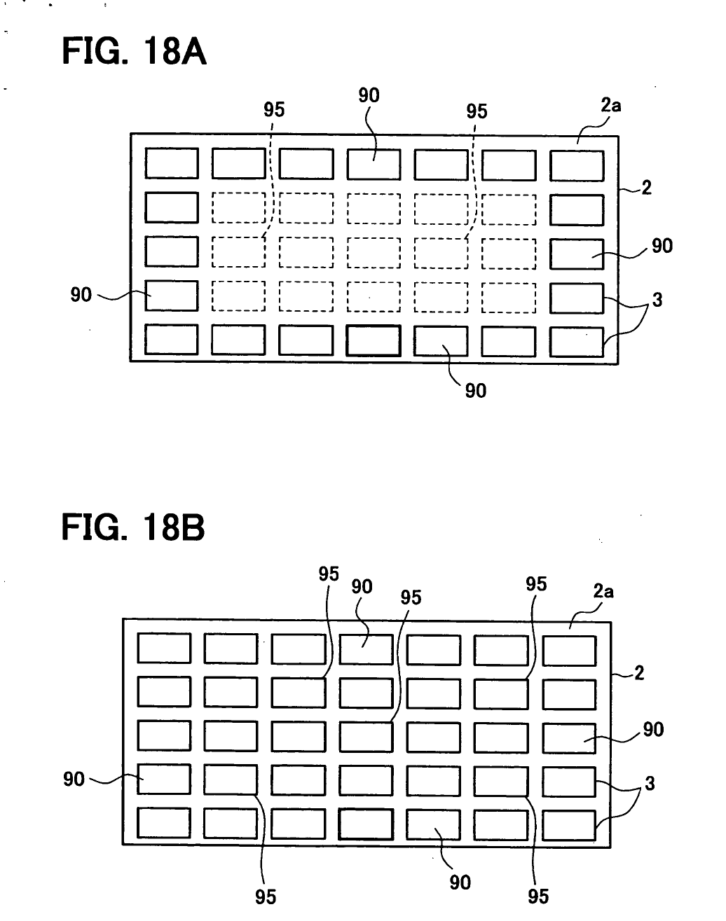

FIGS. 18A and 18B show illustrations of the screen 2a in a run mode and in a stop mode respectively corresponding to the vehicle in a running condition and in a stopping condition. That is, peripheral icons 90 on the periphery of the screen 2a, and central icons 95 are shown in the illustrations. The central icons 95 are icons that are selectable only by operating the operation unit 5 away from the operation guide rail 50 toward a center of the operation plane 4a. The vehicle speed is detected based on a detection signal from the speed sensor 70. When the vehicle speed is determined to be equal to or greater than a predetermined value by the microcomputer 80, only the peripheral icons 90 on the screen 2a are selectable and the central icons 95 are not selectable as shown in FIG. 18A. When the vehicle speed is determined to be smaller than the predetermined value by the microcomputer 80, both the peripheral icons 90 and the central icons 95 on the screen 2a are selectable as shown in FIG. 18B.

The central icons 95 are selectable when the vehicle speed is under the predetermined value (e.g., when the vehicle is stopping), because the user or the driver of the vehicle can afford to watch the operation of the operation unit 5 by his/her own hand for selecting the central icons with detailed operation. On the other hand, when the vehicle is running faster than a predetermined speed, the user cannot afford to watch the operation unit 5 or his hand for providing a detailed control for the operation unit 5 to select the central icons 95. The illustration in FIG. 18A shows that the central icons 95 are represented in a different color (e.g., in a thin color) compared to the peripheral icons 90 on the screen 2a.

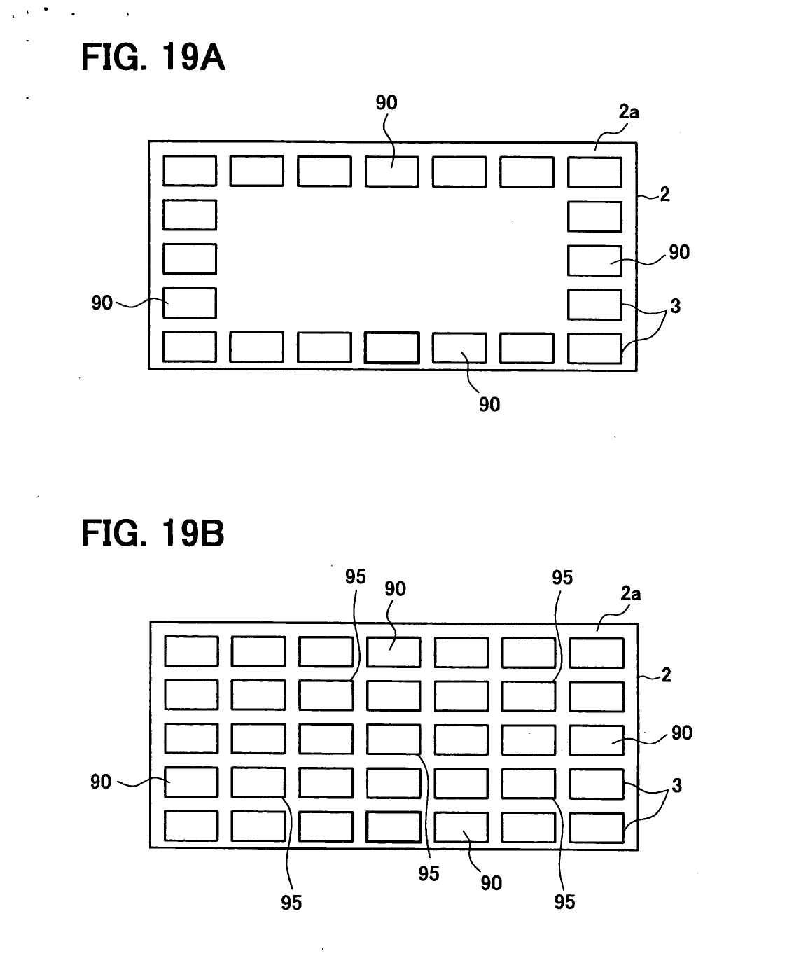

FIGS. 19A and 19B show a different display scheme of the central icons 95 and the peripheral icons 90. That is, in a first display mode in FIG. 19A, only the peripheral icons 90 are displayed on the screen 2a for the vehicle running at or over the predetermined speed, and, in a second display mode in FIG. 19B, the central icons 95 and the peripheral icons 90 are displayed together on the screen for the vehicle running under the predetermined speed. In other words, the central icons 95 disappear from the screen 2a when the vehicle is running over the predetermined speed. In this manner, the screen 2a in a running vehicle is simplified for facilitating an icon selection operation by the user.

FIG. 20 shows a flowchart for a display mode switching process.

In step S15, the process determines whether the vehicle speed less than a preset value. The process proceeds to step S17 when the vehicle speed is smaller than the preset value (step S15:YES). The process proceeds to step S16 when the vehicle speed is equal to or greater than the preset value (step S15:NO).

In step S17, the process uses the second display mode shown in the illustration in FIG. 19B, while in step S16, the process uses the first display mode shown in the illustration in FIG. 19A.

In step S18, the process determines the operation position of the operation unit 5 on the operation plane 4 at a preset interval. The process proceeds to step S19 when the operation unit 5 is operated by the user (when an input from the touch panel 4 is detected) (step S18:YES). The process returns to step S15 when the operation unit 5 is not operated (step S18:NO).

In step S19, the input from the touch panel 4 is processed.

Then, in step S20, the input from switches 6a, 6b is processed.

Then, in step S21, the operation position of the operation unit 5 is converted to a coordinate used in the screen 2a by the control circuit 14. In this process, the input by pressing down the switches 6a, 6b is also converted to a command for controlling the function of the vehicular device.

In step S22, the process sends coordinate information and the command to the display controller 15.

Use of the TFT display panel described above may be replaced with use of plural LEDs as shown in FIG. 11A. The LEDs may be arranged in a row for displaying the selected condition of a specific function by changing its colors. That is, the LED lit in a different color relative to other LEDs indicates the selected condition of the function in as a simulation of pointing by using a pointer on the screen 2a. Further, the pointer may be displayed on a map in a navigation system as shown in FIG. 11B. In this case, the display unit 2 uses the TFT display as a component. That is, the TFT elements arranged in two dimension on the screen 2a are used to display map information. The pointer on the map information is operated according to the operation of the operation unit 5 by the user. Therefore, each of the TFT elements (pixel of an image) is controlled as the selection mark 3 described above. The user may operate switches 6a, 6b for setting, for example, a destination of a travel. Further, the user may have a navigation route displayed on the display unit 2 after setting the destination.

FIG. 4 shows a side view of the operation unit 5. The operation unit 5 includes a magnet 9 and the position detector 4 has a metal plate 8. In this manner, a magnetic force between the magnet 9 and the metal plate 8 keep the operation unit 5 from falling. The magnet 9 and the metal plate 8 may be interchangeable, that is, may switch positions to each other. Further, the operation unit 5 and the position detector 4 may both have the magnet of opposite pole (N pole and S pole) to apply an attractive magnetic force with each other.

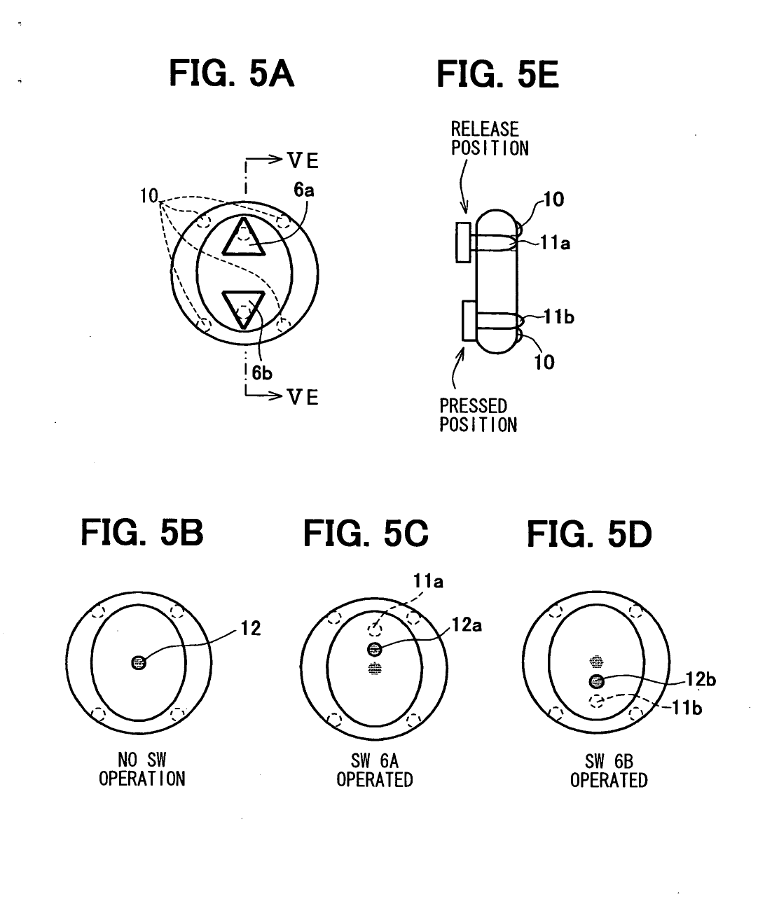

FIG. 5A and FIG. 5E show a top view and a cross sectional view of the operation unit 5. The operation unit 5 has plural feet 10 on its periphery that support the operation unit 5 on the position detector 4. Each of the switches 6a, 6b has a contact rod 11a, 11b respectively that touches the position detector 4 when the switches 6a, 6b are pressed. The switch 6a having the rod 11a and the switch 6b having the rod 11b receive a springy support from a spring (not shown in the figure) for springing back to a release position from a pressed position without having electrically powered mechanism.

The position detector 4 detects the position of a press operation of the switches 6a, 6b in the following manner. That is, only the four feet 10 of the operation unit 5 touch the position detector 4 when the switches 6a, 6b are not pressed. In this case, the position detector 4 detects a position of a gravity center 12 of the four feet 10 of the operation unit 5 as shown in FIG. 5B. When the switch 6a is pressed, the contact rod 11a touches the position detector 4, and as a result, the position of the gravity center of the two feet 10 and the contact rod 11a moves toward the position of the contact rod 11a by a predetermined length. The position detector 4 detects the press operation of the switch 6a by detecting the gravity center moved to the position 12a. In other words, the movement of the gravity center from the position 12 to the position 12a is detected as the press operation of the switch 6a.

FIG. 6 shows a block diagram of the input system 1 described with reference to the illustrations in FIGS. 5A to 5E. In this case, the operation of the operation unit 5 does not require an electric power. Further, the operation of the switch 6a is detected by the position detector 4 to be sent to the control circuit 14 by wire.

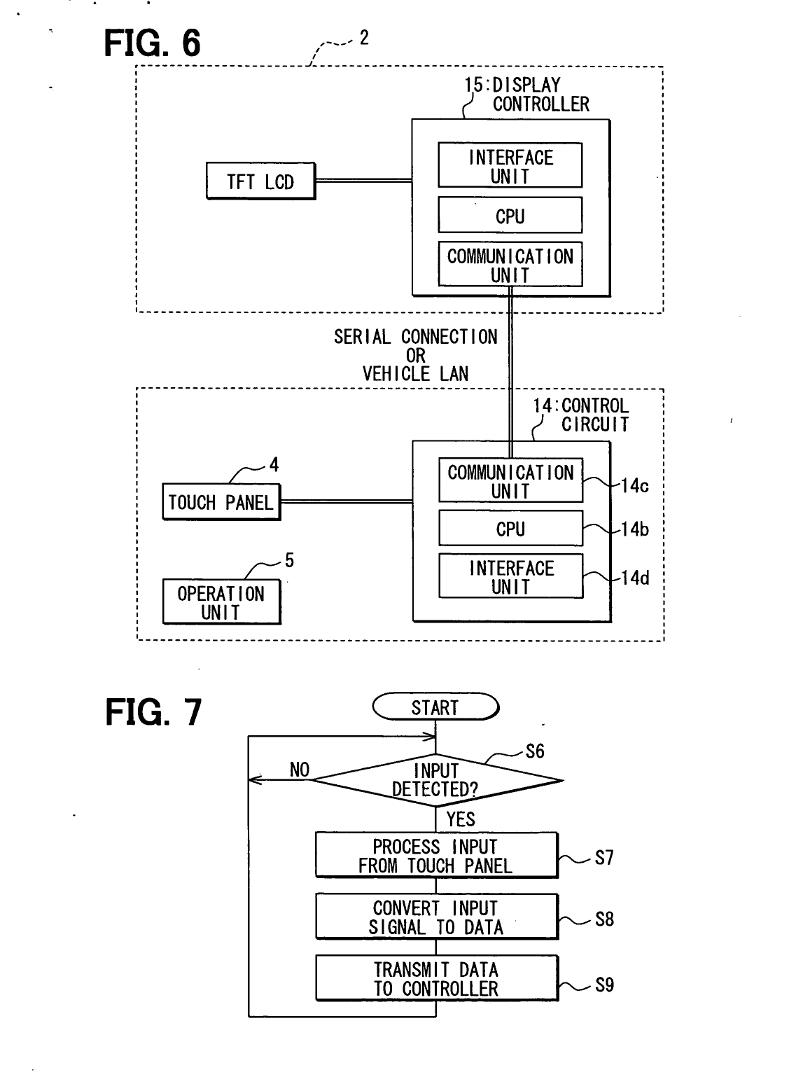

FIG. 7 shows a flowchart of the control process of the input system 1.

In step S6, the process in the control circuit 14 checks an input from the position detector 4 in a predetermined interval for detecting the operation position of the operation unit 5. The process proceeds to step S2 when the input is detected (step S6:YES). The process repeats the input detection when input from the position detector 4 is not detected (step S6:NO).

In step S7, the process detects the input operation from the operation unit 5, that is, the operation position of the operation unit 5 by the user is detected and processed by the position detector 4 together with the input from the switches 6a, 6b.

In step S8, the process converts the operation position of the operation unit 5 to the coordinates of the display unit 2. The operation signal from the switches 6a, 6b upon detecting a press on the switches 6a, 6b is converted to a command for controlling a vehicular device.

In step S9, the process sends coordinate information and the command to the display controller 15 as control data.

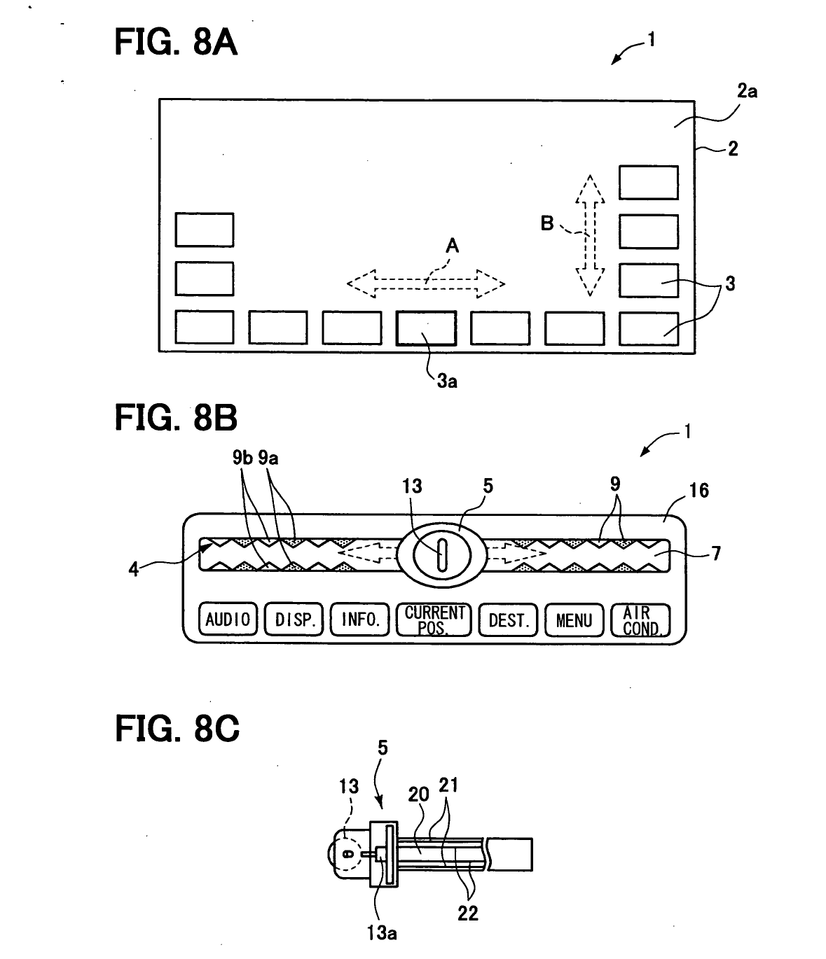

FIGS. 8A to 8C show of a plan view of the input system 1 and a cross-sectional view of the operation unit 5 in a different embodiment. That is, FIG. 8A shows the plan view of the display unit 2 of the input system 1, FIG. 8B shows the plan view of the position detector 4. The display unit 2 includes the screen 2a, and the screen 2a includes plural selection positions 3 arranged in a predetermined direction. On the screen 2a, the selection positions 3 are arranged in a row to form the first array A and the second array B as the selection positions 3 in the previous embodiment. One of the selection position 3 is highlighted as a selected button 3a when it is in a selected condition. The operation unit 5 is operable in a linear manner that corresponds to the arrangement of the selection positions 3 in the first array A. The operation unit 5 has a sub-coordinate input unit 13 for inputting pointer coordinates of the selection positions 3 in the second array B on the screen 2a. That is, the sub-coordinate input unit 13 has a dial for rotatably inputting the transition between the selection positions 3 in the second array B. In addition, the sub-coordinate input unit 13 serves as the switches 6a, 6b. That is, the rotation operation of the dial is considered as the transition between the positions 3, and the press operation of the dial is inputted as an determined input, or an execution command, of the selected button 3a. Further, the pointer on the screen 2a is displayed according to the detected position of the operation unit 5 and the input from the sub-coordinate input unit 13.

More practically, a body 16 of the input system 1 has a guide slot 7 for guiding the linear operation of the operation unit 5. That is, in the guide slot 7 a post 20 of the operation unit 5 is movably disposed. In the guide slot 7, optical sensors 4 are disposed to detect the operation of the operation unit 5. Further, the guide slot 7 has position markers 9 for stepwise movement and positioning at marked positions of the operation unit 5 along the guide slot 7. In this manner, the user has a mechanical feedback to his/her hand with a click sound from the position markers 9 in the guide slot 7 when linearly operating the operation unit 5 for the transition between the selection positions 3. Therefore, the linear movement of the operation unit 5 corresponds to the arrangement of the selection positions 3 in the first array A with the mechanical feedback to the hand that simulates the transition between the selection positions 3 facilitates detailed control of the operation unit 5. Further, one step movement between the position markers 9 may correspondingly make the selected position 3a transit to either of the next selection positions 3 for improved usability.

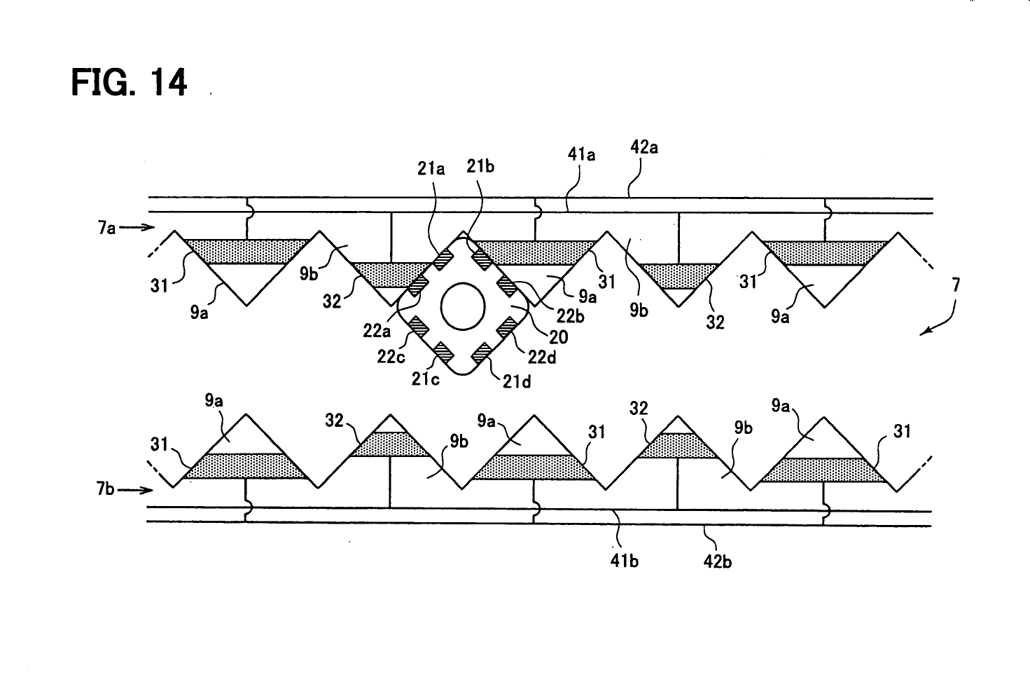

FIG. 14 shows an expanded view of the guide slot 7 with a cross-sectional view of the post 20. The position marker 9 has a power contact 31 and a signal contact 32. The power contact 31 is used to provide an electric power to the operation unit 5, and the signal contact 32 is used to output a determination input signal and a direction input signal from the sub-coordinate input unit 13. In addition, the position markers 9 are categorized into two types, that is, a power position marker 9a having the power contact 31, and a signal position marker 9b having the signal contact 32. The power position markers 9a and the signal position markers 9b are alternately disposed along the guide slot 7. Further, the power position markers 9a and the signal position markers 9b are disposed on both of an upper guide rail 7a and a lower guide rail 7b.

More practically, the power contact 31 is exposed at a first position on both faces of the power position marker 9a, and the signal contact 32 is exposed at a second position on both faces of the signal position marker 9b. The post 20 of the operation unit 5 has a cross-sectional shape that can be engaged with the power position markers 9a and the signal position markers 9b. The post 20 has power contact areas 21a, 21b exposed on a face of the post 20 for contacting the power contact 31 and signal contact areas 22a, 22b exposed on a face of the post 20 for contacting the signal contact 32.

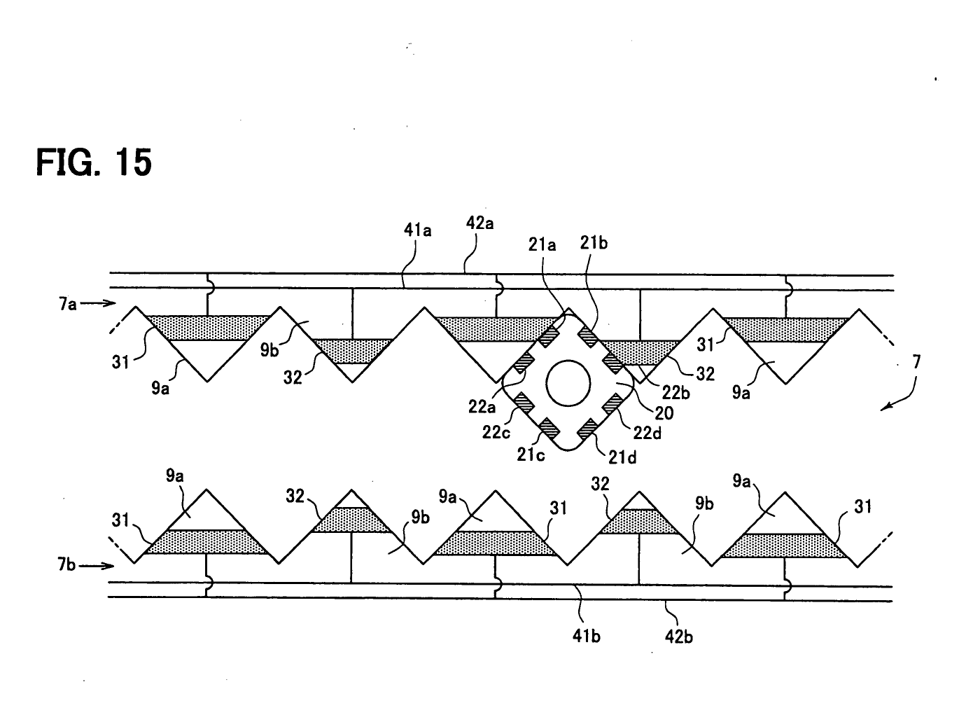

As shown in FIG. 14, when one of the power contact areas 21a, 21b contacts the power contact 31, the other power contact area does not contact the power contact 31, and when one of the signal contact areas 22a, 22b contact the signal contact 32, the other signal contact area does not contact the signal contact 32. For example, the power contact area 21b contacts the power contact 31 and the signal contact area 22a contacts the signal contact 32 in the illustration in FIG. 14. When the operation unit 5 is operated along the guide slot 7, the power contact area 21a contacts the power contact 31 and the signal contact area 22b contacts the signal contact 32 as shown in the illustration in FIG. 15. In this manner, as the operation unit 5 moves along the guide slot 7, contacting faces of the post 20 (both for the power contact areas 21a, 21b and the signal contact areas 22a, 22b) in contact with the power/signal contacts 31, 32 alternate between the right side and the left side.

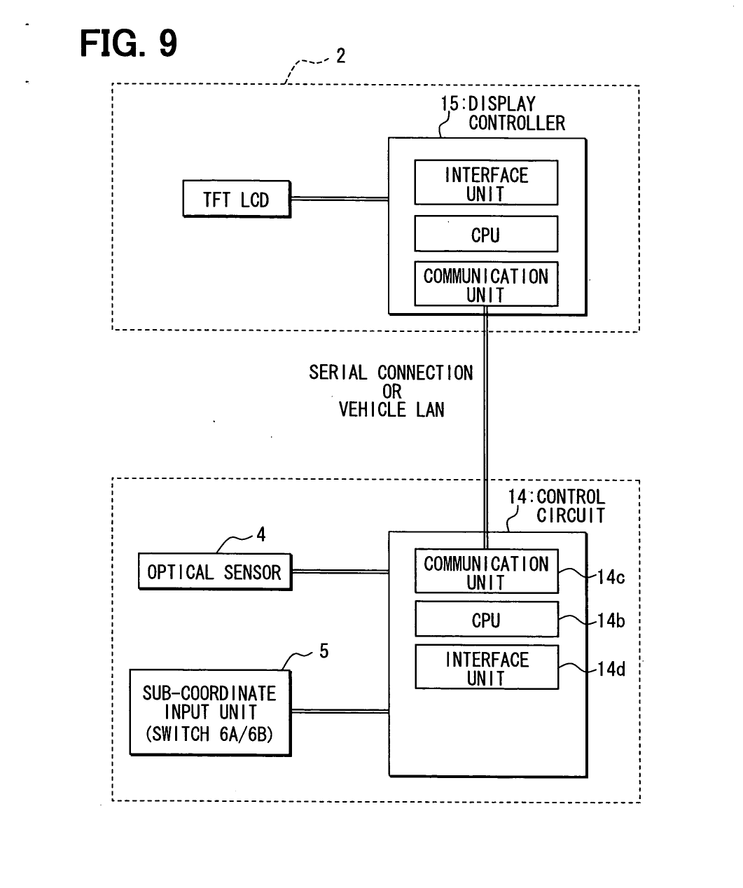

FIG. 9 shows a block diagram of the input system 1 shown in FIGS. 8A and 8B. The optical sensors detects the operation position of the operation unit 5 in the guide slot 7, and outputs the position information to the control circuit 14. The operation of the sub-coordinate input unit 13 outputs sub-coordinate input signal to be sent to the control circuit 14 through the signal contact 32. Further, the press operation of the sub-coordinate input unit 13 outputs the determination input signal to be sent to the control circuit 14 through the signal contact 32.

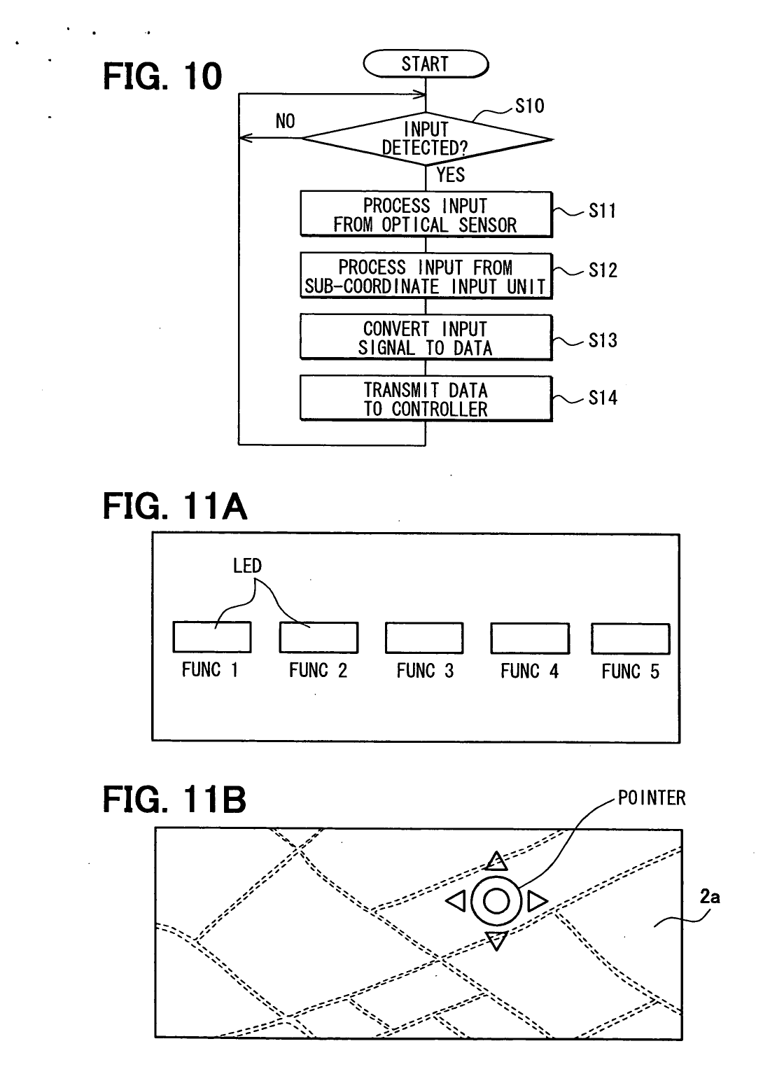

FIG. 10 shows a flowchart of the control process of the input system 1 in the present embodiment.

In step S10, the process in the control circuit 14 checks an input from the optical sensor in a predetermined interval for detecting the operation position of the operation unit 5. The process proceeds to step S11 when the input is detected (step S10:YES). The process repeats the input detection when input from the position detector 4 is not detected (step S10:NO).

In step S11, the process detects the input operation from the operation unit 5, that is, the operation position of the operation unit 5 by the user is detected by the optical sensor and a position signal sent to the control circuit 14.

In step S12, the process detects the input operation of the sub-coordinate input unit 13. That is, the sub-coordinate input signal or the determination input signal is sent to the control circuit 14 through the signal contact 32.

In step S13, the process converts the operation position of the operation unit 5 to the coordinates of the display unit 2. That is, the position signal of the operation unit 5 that represents the operation position of the operation unit 5 in the guide slot 7 in combination with the sub-coordinate input signal from the sub-coordinate input unit 13 is converted to the coordinates of the display unit 2. Further, the determination input signal is converted to a command for controlling a function of the vehicular device.

In step S14, the process sends the coordinate information and the command to the display controller 15 as control data.

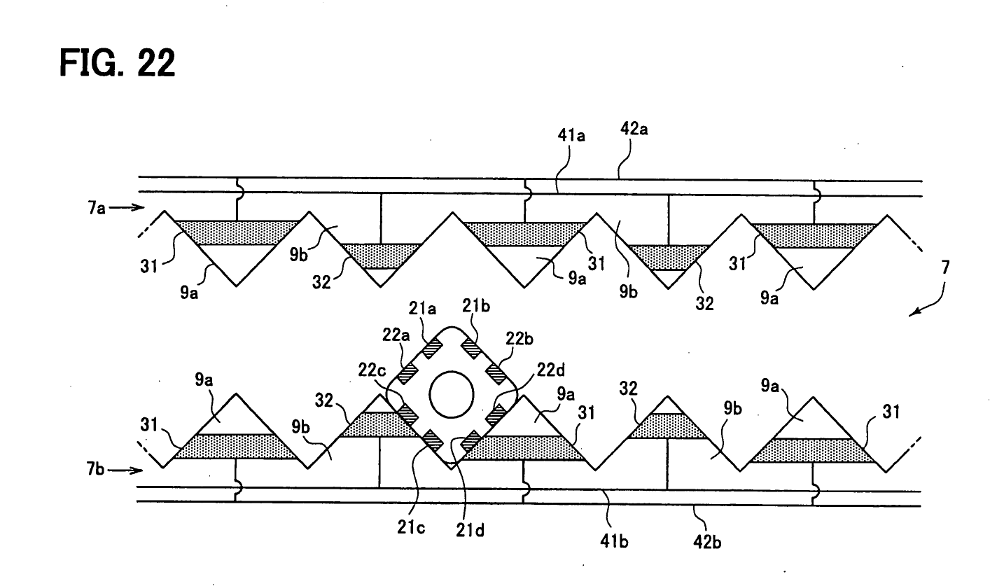

FIG. 22 shows the illustration of the post 20 tilted toward the lower guide rail 7b. The content of the display unit 2 may be alternated according to the upper and the lower side of the guide slot 7 to which the post 20 is contacting.

More practically, the post 20 is tilted to contact the upper guide rail 7a or the lower guide rail 7b either by a force from the user's hand or a force from a force application mechanism (not shown in the figure). In this case, the post 20 has the power contact areas 21c, 21d and the signal contact areas 22c, 22d. The post 20 tilted to the lower guide rail 7b makes one of the signal contact areas 22c, 22d contact the signal contact 32, and the signal from the sub-coordinate input unit 13 is sent to the control circuit 14 through a signal line 42b. In this manner, the control circuit 14 can determine which side of the guide slot 7 the post 20 is contacting. In addition, the control circuit 14 controls alternation of the content of the display unit 2 based on the side to which the post 20 is tilting.

Although the present disclosure has been fully described in connection with the preferred embodiments thereof with reference to the accompanying drawings, it is to be noted that various changes and modifications will become apparent to those skilled in the art.

For example, the operation unit described in the above embodiments may be replaced with other type of devices such as an optical pointer or the like as long as the device is capable of indicating the transition of the location in association with the actual movement of the device.

Such changes and modifications are to be understood as being within the scope of the present invention as defined by the appended claims.

What is claimed is:

1. An input system for a vehicular device comprising:
a display unit for displaying plural menu items in a linear arrangement on a screen, wherein a selection mark indicates selection of one of the plural menu items when the one of the menu items is selected by a user, and wherein the screen of the display unit disposed on an instrument panel faces the user in a front seat of the vehicle;
an operation unit for inputting a transition of selection between the menu items in the linear arrangement by being linearly operable in at least one direction, wherein the operation unit is on one of a right side and a left side of the front seat of the vehicle to be accessible by the user;
a position detector for detecting an operation position of the operation unit;
a selection mark control unit for positioning the selection mark in association with the menu items on the screen according to the operation position of the operation unit detected by the position detector;
a selection input unit for inputting a selection input of the menu item that is marked by the selection mark; and
an input process unit for processing the selection input of the menu item.

2. The input system as in claim 1;
wherein the plural menu items are associated with respectively different functions of the vehicular device, and
the selection input of the menu item marked by the selection mark provides access to one of the functions of the vehicular device.

3. The input system as in claim 1;
wherein the menu items on the screen of the display unit are arranged in two different directions,
a first direction of the arrangement of the menu items and a second direction of the arrangement of the menu items cross each other on the screen,
an operation plane that simulates a planar space on the screen of the display unit two-dimensionally defines the operation position of the operation unit, and
the operation position of the operation unit on the operation plane detected by the position detector determines the selection mark displayed on the screen.

4. The input system as in claim 3,
wherein position detector is a planar position detector that detects a pointing structure on the operation unit by using detection units arranged in two dimensions on the operation plane, and
at least one of the detection units detects the pointing structure on the operation unit and outputs the operation position of the operation unit as a position detection signal.

5. The input system as in claim 2 further comprising:
an operation frame for defining the operation plane; and
an operation guide at an outer periphery of the operation plane on the operation frame for guiding the operation unit,
wherein the plural menu items on the screen are arranged in a linear direction that corresponds to an operation direction of the operation unit along the operation frame.

6. The input system as in claim 5,
wherein the linear arrangement of the plural menu items on an outer periphery of the screen corresponds to a trace of the operation of the operation unit along the operation frame.

7. The input system as in claim 6,
wherein the operation plane takes a shape of an oblong rectangle,
the operation guide is disposed along one of longer sides of the oblong rectangle on a near side relative to the user,
the screen takes the shape of the oblong rectangle for simulating the operation plane, and
the plural menu items are arranged along a lower side of the screen.

8. The input system as in claim 7,
wherein the at least one of a right side and a left side of the operation plane has the operation guide disposed thereon, and
the menu items are arranged on one of a right side and a left side of the screen in a corresponding manner.

9. The input system as in claim 5,
wherein the operation guide protrudes from the operation plane, and
the operation guide in contact with the operation unit guides the operation of the operation unit along an inner side of the operation guide.

10. The input system as in claim 9,
wherein the position detector surrounds the operation plane,
the position detector has a peripheral protruding unit equipped with an operation restriction surface in contact with the operation unit as an inside exposed surface for prohibiting the operation of the operation unit toward an outside of the operation plane, and
at least a portion of the peripheral protruding unit is used as the operation guide.

11. The input system as in claim 5,
wherein the screen has an arrangement of plural peripheral icons along the periphery in accordance with the positions of the plural menu items of the display unit,
the operation plane has plural position detection areas in accordance with the arrangement of the plural peripheral icons, and
one of the plural peripheral icons is selected based on the operation position of the operation unit detected in one of the plural position detection areas.

12. The input system as in claim 11,
wherein one of the plural peripheral icons in a condition of selection is highlighted on the screen relative to the other peripheral icons not in a condition of selection as an alternative of the selection mark.

13. The input system as in claim 11 further comprising:
a speed sensor for detecting a vehicle speed;
a speed analyzer for determining whether the vehicle speed is equal to or greater than a predetermined value based on an output from the speed sensor; and
an selection controller for controlling selection of the icons on the screen based on the vehicle speed,
wherein the screen displays the peripheral icons and central icons that is selectable only in the operation position of the operation unit away from the operation guide toward an inside of the operation plane,
the selection controller allows selection of the peripheral icons and the central icons when the vehicle speed is smaller than the predetermined value, and
the selection controller prohibits selection of the central icons when the vehicle speed is equal to or greater than the predetermined value.

14. The input system as in claim 13 further comprising:
an icon display switching unit in the selection controller for switching an icon display mode between a first display mode that displays only the peripheral icons and a second display mode that displays the peripheral icons and the central icons,
wherein the first display mode is used when the vehicle speed is equal to or greater than the predetermined value, and
the second display mode is used when the vehicle speed is smaller than the predetermined value.

15. The input system as in claim 1 further comprising:
a sub-coordinate input unit in the operation unit for inputting a sub-coordinate that indicates the position of the selection mark in an arrangement direction,
wherein the display unit displays the plural menu items on the screen in two-dimensional linear arrangement defined by a first arrangement direction and a second arrangement direction,
the operation unit is linearly operable only in a direction corresponding to the first arrangement direction on the screen, and
the selection mark control unit determines the position of the selection mark based on the operation position detected by the position detector and the sub-coordinate inputted from the sub-coordinate input unit.

16. The input system as in claim 3 further comprising:
a transmitter in the operation unit for transmitting the selection input as a selection input signal to the input process unit; and
a power unit in the operation unit for providing an electric power for the transmitter.

17. The input system as in claim 3 further comprising:
a touch sensor in the position detector for detecting a position of an object in contact with a surface of the touch sensor,
a first contact on the operation unit that is in contact with the surface of the touch sensor for allowing the position detector to detect the operation position of the operation unit, and
a second contact on the operation unit that protrudes to contact the surface of the touch sensor for allowing the position detector to detect the selection input upon having the selection input.

18. The input system as in claim 15,
wherein the operation unit positioned in a guide rail is linearly movable,
an inner surface of the guide rail has an arrangement of plural position markers that protrudes from the inner surface for providing stepwise movement having a mechanical feedback for the user when the operation unit transits between predetermined positions defined by the plural position markers.

19. The input system as in claim 18,
wherein the position marker has one of a power provision contact for providing an electric power for the operation unit and a signal output contact for outputting the selection input signal from the operation unit and an output signal from the sub-coordinate input unit.

20. The input system as in claim 1,
wherein the vehicular device is a navigation system,
the display unit displays mapped information,
the menu items are pixels for displaying the mapped information, and
the selection mark is used to indicate a specific location of the mapped information specified by the user.

21. The input system as in claim 1,
wherein the operation unit and the position detector are disposed either at a position between the instrument panel and a console box that is located right beside the front seat or at a position right beside the front seat in a center console.
